(19) United States
(12) Patent Application Publication
(10) Pub. No.: US 2024/0309246 A1
(43) Pub. Date: Sep. 19, 2024

(54) NOVEL CROSSLINKABLE COMPOSITION WITH A SILYL TERMINATED POLYMER, AND CORRESPONDING SELF-ADHESIVE ARTICLE

(71) Applicant: Bostik SA, COLOMBES (FR)

(72) Inventors: Foudil MAMERI, Venette (FR); Lahoussaine LALOUCH, Venette (FR); Jean-Marie Bordat, Venette (FR)

(21) Appl. No.: 18/574,959

(22) PCT Filed: Jul. 6, 2022
(86) PCT No.: PCT/FR2022/051353

§ 371 Date: Dec. 28, 2023

(30) Foreign Application Priority Data
Jul. 8, 2021 (FR) FR2107428

(51) Int. Cl. C09J 7/38; C09J 5/00; C09J 11/04; C09J 11/08

(52) U.S. Cl. CPC C09J 7/38; C09J 5/00; C09J 11/04; C09J 11/08; C09J 2301/302; C09J 2483/00

(57) ABSTRACT

1) Crosslinkable adhesive composition comprising:
at least one polymer (A) comprising a hydrolyzable alkoxysilane group;
at least one tackifying resin (B);
at least one pyrogenic silica (C), which is preferably hydrophobic;
at least one crosslinking catalyst (D); and
a silsesquioxane resin (E).

2) Self-adhesive article comprising a support layer coated with a self-adhesive layer consisting of said adhesive composition in the crosslinked state.

3) Process for the manufacture of said article, comprising the crosslinking of said composition by heating at a temperature ranging from 15° C. to 200° C. and adhesive bonding method employing it.

### FIELD OF THE INVENTION

A subject matter of the present invention is a novel crosslinkable adhesive composition based on a polymer comprising at least one hydrolyzable alkoxysilane group. The invention also relates to a self-adhesive article, in particular a self-adhesive support which comprises a support layer coated with a self-adhesive layer consisting of said composition in the crosslinked state. Finally, the invention relates to a process for the manufacture of said article.

### TECHNICAL BACKGROUND

Pressure-sensitive adhesives (PSAs) are substances which confer, on the support layer which is coated with them, an immediate tackiness at ambient temperature. This immediate tackiness, often denoted by the term “tack”, makes possible the instantaneous adhesion of said self-adhesive support to all types of substrates, under the effect of a gentle and brief pressure.

Due to its adhesiveness, usually evaluated by a peel test, said self-adhesive support is then firmly attached to said substrate by means of an adhesive seal.

PSAs are widely used in the manufacture of self-adhesive articles, such as, for example, of self-adhesive labels which are attached to articles for purposes of presentation of information (such as a barcode, name or price) and/or for decorative purposes, whether during permanent or temporary adhesive bonding operations.

PSAs are also employed in the manufacture of self-adhesive tapes of varied uses. Mention may be made, for example, besides the transparent adhesive tape widely used in daily life, of: the forming and the assembling of cardboard packagings; the protection of surfaces for painting operations, in the construction industry; the attachment and the maintenance of various elements, such as panels, bricks, protruding objects, in the construction of buildings or edifices; the attachment and the maintenance of metal, plastic or glass parts, flat or having specific profiles, such as electric cables, plastic films, window panes, metal sheets, inscriptions, logos, parts of seats, dashboards, plastic or textile walls, conduits or pipes for the circulation of fluids, in particular in the transportation industry; the adhesive bonding of fitted carpets by double-sided adhesive tapes in the construction field.

For the purpose of the manufacture of self-adhesive articles (for example of self-adhesive labels and/or tapes), PSAs are generally applied by continuous coating processes over the whole of the surface of a large-sized support layer (if appropriate printable), in the proportion of an amount (generally expressed in g/m²) denoted below by the term of “weight per unit area”. The support layer is, for example, paper or a film consisting of a polymeric material having one or more layers. The layer of self-adhesive composition which covers the support layer can be itself covered with a protective nonstick layer (often known as a release liner), for example consisting of a silicone film. The multilayer system obtained is generally packaged by winding in the form of large reels of up to 2 m in width and 1 m in diameter, which can be stored and transported.

These multilayer systems can subsequently be converted into self-adhesive labels which can be applied by the final user, by means of transformation processes which include the printing of the desired informative and/or decorative elements onto the printable face of the support layer, followed by cutting to the desired shape and sizes. The protective nonstick layer can be easily removed without modifying the adhesive layer, which remains attached to the support layer. After separation from its nonstick protective layer, the label is applied to the article to be coated either manually or with the aid of labelling machines on automated packaging lines.

These multilayer systems can also be converted into self-adhesive tapes by cutting and packaging as rolls of given widths and lengths with, if need be, the cutting or pre-cutting of particular shapes useful for their final use, such as, for example, for the assembly of parts of variable size and of variable shape, in the electronics industry, whether for applications in industry or by the general public.

PSAs make possible, due to their high ambient-temperature tack, rapid holding or attachment of the self-adhesive label and/or tape to the substrate (or article) to be coated (for example, as regards labels, on bottles, or else, as regards tapes, on packing boards to be formed), suitable for the achievement of high industrial production rates.

There exists a field of application of PSAs for which it is desirable for the adhesiveness of the labels and/or tapes on the substrate to be also maintained when the adhesive seal providing the attachment is exposed (just as, consequently, the article coated with the label and/or the tape) to a temperature capable of varying within a wide range. Mention may be made, by way of example, of the positioning of labels on certain components of motor vehicles (or other vehicles) located close to the engine, or on packing materials designed to receive a hot liquid during their packaging, or else on articles (such as tires) which are labelled when hot, on departing from the manufacturing lines. Mention may also be made of the use of self-adhesive tapes for the assembling of parts for which a good thermal resistance is necessary, as in the case, for example, of the interior trim of planes or other vehicles.

PSAs often used for this field of application comprise polymers (or copolymers) of the acrylate type of very high number-average molecular weight (Mn). The latter are provided in the form of an aqueous emulsion or of an organic solution. However, the coating of such PSAs on a support layer is complicated, at the industrial level, by the fact that it is necessary to provide either an additional stage of drying of the emulsion, or specific plants, taking into account the problems of industrial health and safety related to the evaporation of the organic solvent. In both cases, the disadvantages related to the unpleasant smell of the acrylics also have to be taken into account.

The U.S. Pat. No. 6,486,229 describes a UV-crosslinkable hot-melt adhesive composition comprising a tackifying resin, a photoinitiator and a multiblock radial styrene-butadiene copolymer, the butadiene block of which has a high content of pendent vinyl group. This composition is coated in the noncrosslinked state on a support layer, then crosslinked by exposure to ultraviolet radiation. The self-adhesive support thus obtained is particularly suitable for the applications of tapes and labels for which good cohesion at high temperatures is required. The international application WO 2004/011559 describes an acrylic composition capable of being coated which comprises an acrylic copolymer, a photoinitiator and a polyfunctional (meth)acrylate. This composition can also be crosslinked by exposure to ultraviolet radiation to give a high-performance PSA.

These techniques for obtaining PSAs by ultraviolet radiation exhibit, however, disadvantages which emerge from the problems of industrial health related to UV lamps and from the costs associated with the short lifetime of these lamps. Furthermore, in the case of self-adhesive supports having a high weight per unit area of PSA, for example a weight per unit area of greater than 150 g/m², it is difficult to ensure that the adhesiveness is maintained in a wide temperature range, and in particular at high temperature, due to the difficulty of penetration of the UV radiation over the entire thickness of the crosslinkable adhesive layer. Finally, another disadvantage of the crosslinking by exposure to UV radiation is that the crosslinking stops as soon as the composition is no longer exposed to UV radiation; thus, the crosslinking reaction cannot continue and ends after the coated support layer has exited from the production line, for example during storage.

There are already known, in particular by the three patent applications of Bostik SA: WO 09/106699, EP 2 336 208 and WO 2020/128200, adhesive compositions based on polyurethane (or polyether) having alkoxysilane ends which are crosslinkable by heating. These adhesive compositions are advantageously devoid of solvent and of water. Their coating on a support and their heating, to a temperature of between 50° C. and 150° C., results, after a chemical crosslinking reaction also carried out in the presence of moisture, in the production of a self-adhesive support which exhibits the required properties of adhesiveness (or peel) and of tack. This crosslinking reaction results in the formation of an adhesive seal which has a three-dimensional polymer network structure comprising siloxane bonds and which provides the attachment of the self-adhesive support to the substrate. Said self-adhesive support can thus be used for the manufacture of self-adhesive labels and/or tapes.

The patent application WO 12/090151 of Bostik SA describes a method for the crosslinking of an adhesive composition based on polyurethane (or polyether) having alkoxysilane ends, which employs a guiding means of Caroll type in a climate-controlled chamber, the temperature of which is of between 50° C. and 200° C. and the relative humidity of which is controlled, preferably at a value of approximately 50%.

The patent application FR 3 013 993 of Bostik SA describes a process for the application of an adhesive composition comprising a reactive prepolymer, in particular a prepolymer having alkoxysilane ends, said process comprising the heating of said composition in line by supplying electricity to an inductive cable, upstream of its hot application to a support using an application nozzle and at a temperature of between 50° C. and 200° C.

The aim of the present invention is to simplify the process for the manufacture of a self-adhesive article, in particular of a self-adhesive support, by crosslinking of a crosslinkable adhesive composition based on a polymer having an alkoxysilane end.

Another aim of the present invention is to provide a crosslinkable adhesive composition based on a polymer having an alkoxysilane end which makes it possible to manufacture a self-adhesive article, in particular a self-adhesive support, by crosslinking at a lower temperature, in particular at a temperature of less than 50° C., and even at ambient temperature.

Another aim of the present invention is to provide a crosslinkable adhesive composition based on a polymer having an alkoxysilane end which makes it possible to manufacture a self-adhesive article, in particular a self-adhesive support, by crosslinking without control or regulation of the relative humidity.

Another aim of the present invention is to provide a crosslinkable adhesive composition which crosslinks at ambient temperature and/or ambient humidity in a reduced time.

Another aim of the present invention is to provide a crosslinkable adhesive composition which results, after coating on a support and then crosslinking, in a pressure-sensitive adhesive having suitable properties of adhesiveness and of tack.

Another aim of the invention is for the adhesive seal which provides the attachment of the self-adhesive support thus obtained to a substrate to retain the required cohesion over a wide temperature range, including for high weights per unit area of PSA.

Another aim of the invention is for the adhesive seal to exhibit an improved mechanical strength.

It has now been found that these aims can be completely or partially achieved by means of the adhesive composition and of the self-adhesive support which are described below.

### DESCRIPTION OF THE INVENTION

### Crosslinkable Adhesive Composition:

A subject-matter of the present invention is thus, firstly, a crosslinkable adhesive composition, characterized in that it comprises:
at least one polymer (A) comprising a hydrolyzable alkoxysilane group;
at least one tackifying resin (B);
at least one pyrogenic silica (C); and
at least one crosslinking catalyst (D).

It has now been found that said crosslinkable composition offers a considerably reduced crosslinking time, at ambient temperature and ambient humidity. It can thus advantageously result, after its coating on a support layer and its crosslinking, in a self-adhesive support, at the end of a process which employs a stage of heating at a lower temperature and does not require a high relative humidity, or even at the end of a process which does not require a stage of heating and/or of control of the humidity.

Furthermore, said self-adhesive support also exhibits compliant properties of adhesiveness (or peel) on a substrate, such as stainless steel, which render it capable of being firmly attached to said substrate. The adhesive seal which provides the attachment of said support to the substrate retains, entirely surprisingly, a much better temperature cohesion, by virtue of an improved resistance in the shear tests at constant temperature at 125° C.

Finally, the self-adhesive layer consisting of the crosslinkable adhesive composition in the crosslinked state advantageously has a greater mechanical strength, quantified by measurement of the breaking stress.

### Polymer (A):

Within the meaning of the present invention, the term “polymer (A) comprising a hydrolyzable alkoxysilane group” is understood to mean a polymer which comprises at least one, and preferably at least two, hydrolyzable groups of formula (I):

Si(R⁴)ₚ(OR⁵)₃₋ₚ (I)

in which:
R⁴ represents a linear or branched alkyl radical comprising from 1 to 4 carbon atoms, with the possibility that, when there are several R⁴ radicals, these radicals are identical or different;
R⁵ represents a linear or branched alkyl radical comprising from 1 to 4 carbon atoms, with the possibility that, when there are several R⁵ radicals, these radicals are identical or different, with the possibility that two OR⁵ groups can participate in one and the same ring; and
p is an integer equal to 0, 1 or 2, preferably equal to 0 or 1.

The hydrolyzable alkoxysilane group is preferably positioned at the end of said polymer. However, a position in the middle of the chain is not excluded. The polymer (A) is not crosslinked before the application of the adhesive composition. The adhesive composition is applied under conditions which make possible its crosslinking.

The polymer (A) is thus a silyl-modified polymer which is generally provided in the form of a more or less viscous liquid. Preferably, the polymer (A) exhibits a viscosity, in particular at 23° C., ranging from 10 to 200 Pa·s, preferably ranging from 20 to 175 Pa·s, said viscosity being measured, for example, according to a method of Brookfield type at 23° C. and 50% relative humidity (S28 needle).

The polymer (A) preferably comprises two groups of formula (I) but it can also comprise from three to six groups of formula (I).

Preferably, the polymer(s) (A) exhibit a number-average molecular weight (Mn) ranging from 500 to 50 000 g/mol, more preferably ranging from 700 to 20 000 g/mol. The number-average molecular weight (Mn) of the polymers can be calculated or measured by methods well known to a person skilled in the art, for example by NMR and size exclusion chromatography using standards of polystyrene type.

According to one embodiment of the invention, the polymer (A) corresponds to one of the formulae (II), (III) or (IV):

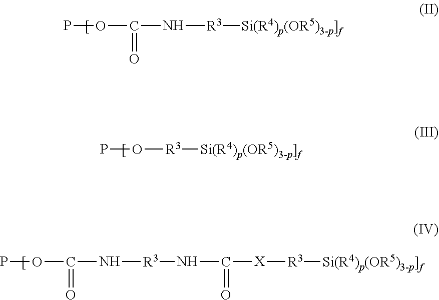

in which:
   R⁴, R⁵ and p have the same meaning as in the formula (I) described above,
   P represents a saturated or unsaturated, linear or branched, polymeric radical optionally comprising one or more heteroatoms, such as oxygen, nitrogen, sulfur or silicon, and preferably exhibiting a number-average molecular weight (Mn) ranging from 100 g/mol to 48 600 g/mol, more particularly from 300 g/mol to 18 600 g/mol or also from 500 g/mol to 12 600 g/mol,
   R¹ represents a divalent hydrocarbon radical comprising from 5 to 15 carbon atoms which can be aromatic or aliphatic, linear, branched or cyclic,
   R³ represents a linear or branched divalent alkylene radical comprising from 1 to 6 carbon atoms, preferably from 1 to 3 carbon atoms,
   X represents a divalent radical chosen from —NH—, —NR⁷— or —S—,
   R⁷ represents a linear or branched alkyl radical comprising from 1 to 20 carbon atoms and which can also comprise one or more heteroatoms, and
   f is an integer ranging from 1 to 6, preferably ranging from 2 to 5, preferably ranging from 2 to 4, more preferably ranging from 2 to 3.

Preferably, in the formulae (II), (III) and/or (IV) above, P represents a polymeric radical chosen, in a nonlimiting manner, from polyethers, polycarbonates, polyesters, polyolefins, polyacrylates, polyether polyurethanes, polyester polyurethanes, polyolefin polyurethanes, polyacrylate polyurethanes, polycarbonate polyurethanes, and block polyether/polyester polyurethanes.

For example, the document EP 2 468 783 describes silyl-modified polymers of formula (II) in which P represents a polymer radical having polyurethane/polyester/polyether blocks.

According to one embodiment, the silyl-modified polymers are chosen from silyl-modified polyurethanes, silyl-modified polyethers and their mixtures.

According to a particular embodiment, the silyl-modified polymer (A) corresponds to one of the formulae (II′), (III′) or (IV′):

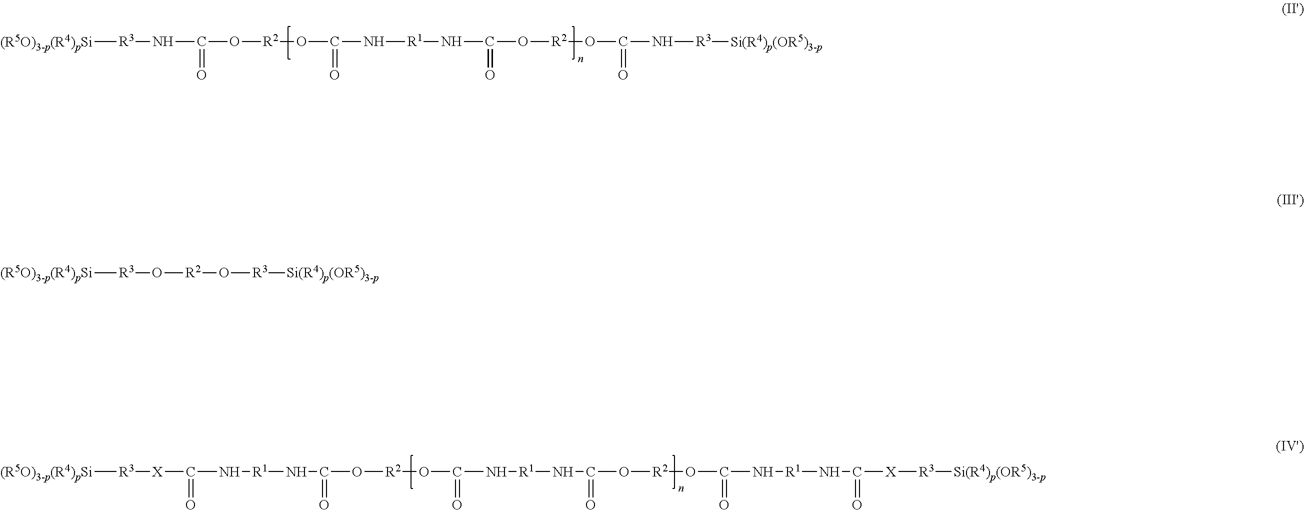

in which:
R¹, R³, R⁴, R⁵, X, R⁷ and p have the same meaning as in the formulae (II), (III) and (IV) described above,
R² represents a saturated or unsaturated, linear or branched, divalent hydrocarbon radical optionally comprising one or more heteroatoms, such as oxygen, nitrogen, sulfur or silicon, and preferably exhibiting a number-average molecular weight (Mn) ranging from 100 g/mol to 48 600 g/mol, more particularly from 300 g/mol to 18 600 g/mol or also from 500 g/mol to 12 600 g/mol, and
n is an integer greater than or equal to 0.

In the silyl-modified polymers of formulae (II′), (III′) or (IV′) defined above, when the R² radical comprises one or more heteroatoms, said heteroatom(s) are not present at the chain end. In other words, the free valencies of the divalent R² radical bonded to the neighboring oxygen atoms of the silyl-modified polymer each originate from a carbon atom. Thus, the main chain of the R² radical is terminated by a carbon atom at each of the two ends, said carbon atom then exhibiting a free valency.

According to one embodiment, the silyl-modified polymers (A) are obtained from polyols chosen from polyether polyols, polyester polyols, polycarbonate polyols, polyacrylate polyols, polysiloxane polyols and polyolefin polyols and their mixtures, and more preferably from diols chosen from polyether diols, polyester diols, polycarbonate diols, polyacrylate diols, polysiloxane diols, polyolefin diols and their mixtures. In the case of the polymers of formulae (II′), (III′) and (IV′) described above, such diols can be represented by the formula HO—R²—OH where R² has the same meaning as in the formulae (II′), (III′) or (IV′).

For example, among the radicals of R² type which can be present in the formulae (II′), (III′) and (IV′), mention may be made of the following divalent radicals, the formulae of which below show the two free valencies:
derivative of a polypropylene glycol:

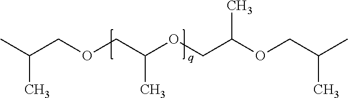

derivative of a polyester diol:

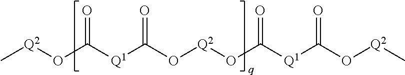

derivative of a polybutadiene diol:

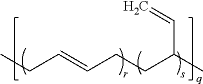

derivative of a polyacrylate diol:

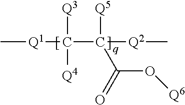

derivative of a polysiloxane diol:

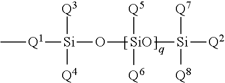

In the above formulae, the meaning of the radicals and indices is as follows:
q represents an integer such that the number-average molecular weight of the R² radical ranges from 100 g/mol to 48 600 g/mol, preferably from 300 g/mol to 18 600 g/mol, more preferably from 500 g/mol to 12 600 g/mol,
r and s represent zero or a nonzero integer such that the number-average molecular weight (Mn) of the R² radical ranges from 100 g/mol to 48 600 g/mol, preferably from 300 g/mol to 18 600 g/mol, more preferably from 500 g/mol to 12 600 g/mol, it being understood that the sum r+s is other than zero,
Q¹ represents a saturated or unsaturated, linear or branched aliphatic or aromatic divalent alkylene radical preferably exhibiting from 1 to 18 carbon atoms, more preferably from 1 to 8 carbon atoms,
Q² represents a linear or branched divalent alkylene radical preferably exhibiting from 2 to 36 carbon atoms, more preferably from 1 to 8 carbon atoms,
Q³, Q⁴, Q⁵, Q⁶, Q⁷ and Q⁸ represent, independently of one another, a hydrogen atom or an alkyl, alkenyl or aromatic radical preferably exhibiting from 1 to 12 carbon atoms, preferably from 2 to 12 carbon atoms, more preferably from 2 to 8 carbon atoms.

According to one embodiment of the composition according to the invention, the silyl-modified polymer (A) is such that the R² radical which appears in the formulae (II′), (III′) and (IV′) represents a polyether radical, preferably a poly(oxyalkylene) radical and more preferably still a radical derived from a polypropylene glycol corresponding to the formula indicated above.

According to one embodiment, R¹ is chosen from one of the following divalent radicals, the formulae of which below show the two free valencies:
a) the divalent radical derived from isophorone diisocyanate (IPDI):

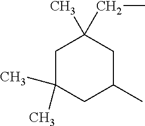

b) the divalent radical derived from dicyclohexylmethane diisocyanate (H12MDI)

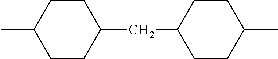

c) the divalent radical derived from toluene diisocyanate (TDI)

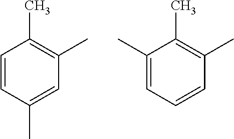

d) the divalent radicals derived from the 4,4′ and 2,4′ isomers of diphenylmethane diisocyanate (MDI)

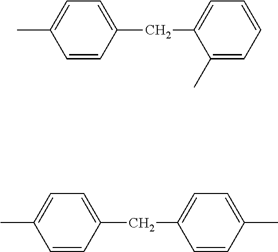

e) the divalent radical derived from hexamethylene diisocyanate (HDI) —(CH₂)₆—
f) the divalent radical derived from m-xylylene diisocyanate (m-XDI).

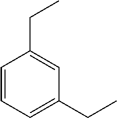

The polymers of formula (II) or (II′) can be obtained according to a process described in the documents EP 2 336 208 and WO 2009/106699. A person skilled in the art will know how to adapt the manufacturing process described in these two documents in the case of the use of different types of polyols. Mention may be made, among the polymers corresponding to the formula (II), of:
Geniosil® STP-E10 (available from Wacker): polyether comprising two groups (I) of dimethoxy type (n equal to 0, p equal to 1 and R⁴ and R⁵ represent a methyl group) exhibiting a number-average molecular weight of 8889 g/mol where R³ represents a methyl group;
Geniosil® STP-E30 (available from Wacker): with a number-average molecular weight of 14 493 g/mol, it is a polypropylene glycol with two end groups consisting of a dimethoxy(methyl)silylmethylcarbamate, i.e., in the formula (II′): n is equal to 0; p is equal to 1; R⁴ and R⁵ represent a methyl group and R³ represents a methyl group;
Desmoscal® S XP 2636 (available from Bayer): polyurethane comprising two groups (I) of trimethoxy type (n other than 0, p equal to 0 and R⁵ represents a methyl group) exhibiting a number-average molecular weight of 15 038 g/mol where R³ represents an n-propylene group.

The polymers of formula (III) or (III′) can be obtained by hydrosilylation of polyether diallyl ether according to a process described, for example, in the document EP 1 829 928. Mention may be made, among the polymers corresponding to the formula (III), of:
the polymer MS SAX® 350 (available from Kaneka) corresponding to a polyether comprising two groups (I) of dimethoxy type (p equal to 1 and R⁴ and R⁵ represent a methyl group) having a number-average molecular weight ranging from 14 000 to 16 000 g/mol;
the polymer MS SAX® 260 (available from Kaneka) corresponding to a polyether comprising two groups (I) of dimethoxy type (p equal to 1 and R⁴ and R⁵ represent a methyl group) exhibiting a number-average molecular weight of 16 000 to 18 000 g/mol where R³ represents an ethyl group;
the polymer MS S303H (available from Kaneka) corresponding to a polyether comprising two groups (I) of dimethoxy type (p is equal to 1 and R⁴ represents a methyl group) having a number-average molecular weight of approximately 22 000 g/mol.

The polymers of formula (IV) or (IV′) can, for example, be obtained by reaction of polyol(s) with one or more diisocyanate(s) followed by a reaction with aminosilanes or mercaptosilanes. A process for the preparation of polymers of formula (IV) or (IV′) is described in the document EP 2 583 988. A person skilled in the art will know how to adapt the manufacturing process described in this document in the case of the use of different types of polyols. Mention may be made, among the polymers corresponding to the formula (IV) or (IV′), of:
Spur+® 1050MM (available from Momentive): polyurethane comprising two groups (I) of trimethoxy type (n other than 0, p equal to 0 and R⁵ represents a methyl group) exhibiting a number-average molecular weight of 16 393 g/mol where R³ represents an n-propyl group;
Spur+® Y-19116 (available from Momentive): polyurethane comprising two groups (I) of trimethoxy type (n other than 0 and R⁵ represents a methyl group) exhibiting a number-average molecular weight ranging from 15 000 to 17 000 g/mol where R³ represents an n-propyl group.

According to a preferred embodiment of the invention, the adhesive composition comprises at least one silyl-modified polymer (A) of formula (II) and/or (II′) or at least one silyl-modified polymer of formula (III) and/or (III′).

According to a very particularly preferred embodiment of the invention, the polymer (A) is a silyl-modified polymer of formula (II′) in which n is equal to 0, R² is a divalent radical derived from a polyether, preferably from a poly(oxyalkylene) diol and more particularly still from a polypropylene glycol.

### Tackifying Resin (B):

The crosslinkable adhesive composition according to the invention also comprises at least one tackifying resin (B).

Said resin can be any resin compatible with the silyl-modified polymer(s) (A).

The term “compatible tackifying resin” is understood to denote a tackifying resin which, when it is mixed in the 50%/50% proportions (in particular by weight) with the polymer(s) (A), gives a substantially homogeneous mixture.

The resins (B) are advantageously chosen from:
(i) resins obtained by polymerization of terpene hydrocarbons and of phenols, in the presence of Friedel-Crafts catalysts;
(ii) resins obtained by a process comprising the polymerization of α-methylstyrene, it also being possible for said process to comprise a reaction with phenols;
(iii) rosins of natural origin or modified rosins (such as, for example, the rosin extracted from pine gum, wood rosin extracted from tree roots and their derivatives which are hydrogenated, dimerized, polymerized or esterified with monoalcohols or polyols, such as glycerol or pentaerythritol);
(iv) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum fractions;
(v) terpene resins (which generally result from the polymerization of terpene hydrocarbons, such as, for example, monoterpene (or pinene), in the presence of Friedel-Crafts catalysts);
(vi) copolymers based on natural terpenes (such as, for example, styrene/terpene, α-methylstyrene/terpene and vinyltoluene/terpene); or else
(vii) acrylic resins having a viscosity at 100° C. of less than 100 Pa·s;
and also from the mixtures of these resins.

Such resins are commercially available and, among those of types (i), (ii), (iii) and (iv) defined above, mention may be made of the following products:
resins of type (i): Dertophene® 1510 available from DRT having a number-average molecular weight (Mn) of approximately 870 Da; Dertophene® H150 available from the same company with a number-average molecular weight (Mn) equal to approximately 630 Da; Sylvarez® TP 95 available from Arizona Chemical having a number-average molecular weight (Mn) of approximately 1200 Da;
resins of type (ii): Cleartack® W100, available from Cray Valley, which is obtained by polymerization of α-methylstyrene without action of phenols, with a number-average molecular weight (Mn) of 900 Da; Sylvarez® 510, which is also available from Arizona Chemical, with a number-average molecular weight (Mn) of approximately 1740 Da, the process for the production of which comprises also the addition of phenols;
resins of type (iii): Sylvalite® RE 100, which is an ester of rosin and pentaerythritol available from Arizona Chemical and with a number-average molecular weight (Mn) of approximately 1700 Da;
resins of type (iv): Picco® AR100 available from Eastman and with a number-average molecular weight (Mn) of approximately 550 g/mol.

According to a preferred alternative form, use is made, as resin (B), of a resin chosen from those of type (i) or (iv).

### Pyrogenic Silica (C):

Pyrogenic silica (also called “fumed silica”) is provided in the form of very fine silica particles (of the order of a nanometer), with a very low apparent density and with a very high specific surface. Pyrogenic silica can be obtained by pyrolysis, in the presence of hydrogen and oxygen, of silicon compounds, such as silicon tetrachloride, itself prepared from silicon and chlorine.

Pyrogenic silica is initially hydrophilic, due to the presence of silanol (Si—OH) groups at the surface of its constituent particles. It can be rendered hydrophobic by reaction of these silanol groups with various reactants, generally a silicone oil, such as PolyDiMethylSiloxane (PDMS).

Preferably, the pyrogenic silica (C) is a hydrophobic pyrogenic silica.

According to one embodiment, the hydrophobic pyrogenic silica (C) is obtained by treatment of a pyrogenic silica with a polydimethylsiloxane.

According to one embodiment, the pyrogenic silica (C) has a BET specific surface of at least 10 m²/g, preferably ranging from 50 to 400 m²/g, more preferably still from 80 to 290 m²/g. The BET specific surface is measured, in a way well known to a person skilled in the art, by determination of an adsorption isotherm based on the Brunauer, Emmett and Teller (BET) method, for example according to the standard ISO 9277 of September 2010.

According to another embodiment, the pyrogenic silica (C) is obtained by a compaction treatment, for example from a roller compactor or from the process described by the patent EP 0 280 851. The apparent density is quantified by a measurement of the tamped apparent density, measured according to the standard ISO 787/11 of August 1983, which is generally within a range extending from 50 to 200 g/l.

Such pyrogenic silicas, in particular hydrophobic pyrogenic silicas, are commercially available, such as the products of the Aerosil® range from Evonik.

Mention may in particular be made, as example of hydrophobic pyrogenic silica (C), of Aerosil® R202, the BET specific surface of which is 100±20 m²/g, the tamped apparent density approximately 60 g/l and which is rendered hydrophobic by treatment with polydimethylsiloxane. The constituent particles of Aerosil® R202 have a size of approximately 16 nm.

### Crosslinking Catalyst (D):

The crosslinking catalyst (D) which can be used in the composition according to the invention can be any catalyst known to a person skilled in the art for silanol condensation. Mention may be made, as examples of such catalysts, of organic derivatives of titanium, such as titanium acetylacetonate (available commercially under the name Tyzor® AA75 from DuPont), aluminum, such as aluminum chelate (available commercially under the name K-KAT® 5218 from King Industries), or amines, such as 1,8-diazobicyclo[5.4.0]undec-7-ene or DBU.

### Silsesquioxane Resin (E):

Besides the ingredients (A), (B), (C) and (D), the crosslinkable adhesive composition according to the invention can also comprise, optionally, a silsesquioxane resin (E).

According to a preferred alternative form of the invention, the crosslinkable adhesive composition according to the invention comprises at least one such silsesquioxane resin.

Silsesquioxane resins are organosilicon compounds which can adopt a polyhedral structure or a polymeric structure, with Si—O—Si bonds. They generally have the following general formula:

[RSiO_{3/2}]ₜ
in which R, of identical or different nature, represents an organic radical and t is an integer which can vary from 6 to 12, t preferably being equal to 6, 8, 10 or 12.

According to one embodiment, the silsesquioxane (E) has a polyhedral structure (or POSS for “Polyhedral Oligomeric Silsesquioxane”).

Preferably, the silsesquioxane (E) corresponds to the following general formula (V):

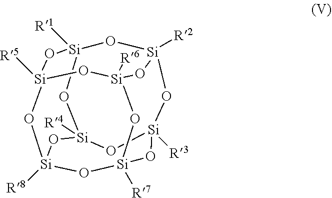

in which each of R′¹ to R′⁸ represents, independently of one another, a group chosen from:
   a hydrogen atom,
   a radical chosen from the group consisting of a linear or branched C₁-C₄ alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
   an —OSiR′⁹R′¹⁰ group in which R′⁹ and R′¹⁰ each represents, independently of each other, a hydrogen atom or a radical chosen from the group consisting of linear or branched C₁-C₄ alkyls, linear or branched C₁-C₄ alkoxys, C₂-C₄ alkenyls, a phenyl, a C₃-C₆ allyl radical, a cyclic C₃-C₈ aliphatic radical and a C₁-C₄ acyl radical;
   provided:
      that at least one radical among the R′¹ to R′⁸ radicals is a C₁-C₄ alkoxy radical; and
      that at least one radical among the R′¹ to R′⁸ radicals is a phenyl radical.

In particular, the silsesquioxane (E) is a dimethylmethoxyphenylsiloxane (CAS number=68957-04-0).

Silsesquioxanes are known compounds which are described in particular in the patent application WO 2008/107331. Some are also commercially available, such as the product from Dow sold under the name: Dow Corning® 3074 and Dow Corning® 3037 (CAS number=68957-04-0).

### Other Additives:

The crosslinkable adhesive composition according to the invention can also comprise one or more additives chosen from the group consisting of moisture absorbers, plasticizers, antioxidants, pigments, dyes, adhesion promoters, UV stabilizers, flame-retardant additives and also fillers, such as carbonate-based fillers, for example of calcium carbonate type.

The moisture absorber (or drying agent) can, for example, be chosen from nonpolymeric hydrolyzable alkoxysilane derivatives, with a molecular weight of less than 500 g/mol, preferably chosen from trimethoxysilane and triethoxysilane derivatives. Such an agent can typically extend the shelf life of the composition during storage and transportation before it is used. Mention may be made, for example, of γ-methacryloyloxypropyltrimethoxysilane (for example available, under the trade name Silquest® A-174, from Momentive), methacryloyloxymethyltrimethoxysilane (for example available, under the name Geniosil® XL33, from Wacker), vinyltrimethoxysilane, isooctyltrimethoxysilane or phenyltrimethoxysilane.

When it is present, the moisture absorber can represent, for example, from 0.1% to 3% by weight or from 1% to 2% by weight, with respect to the total weight of the composition according to the invention.

The composition according to the invention can also comprise a plasticizer.

Use may be made, as examples of plasticizers which can be used, of any plasticizer generally used in the field of adhesives, such as, for example, phthalates, benzoates, trimethylolpropane esters, trimethylolethane esters, trimethylolmethane esters, glycerol esters, pentaerythritol esters, naphthenic mineral oils, adipates, cyclohexanedicarboxylates, liquid paraffins, natural oils (optionally epoxidized), polypropylenes, polybutylenes, hydrogenated polyisoprenes and their mixtures.

Mention may be made, among the phthalates, for example, of diisononyl phthalate, diisobutyl phthalate, dioctyl phthalate, dicyclohexyl phthalate, diisooctyl phthalate, diisododecyl phthalate, dibenzyl phthalate or butyl benzyl phthalate.

Mention may be made, among the benzoates, for example, of: neopentyl glycol dibenzoate (for example available under the name Uniplex® 512 from Lanxess), dipropylene glycol dibenzoate (for example available under the name Benzoflex® 9-88SG from Eastman), a mixture of diethylene glycol dibenzoate and of dipropylene glycol dibenzoate (for example available under the name K-Flex® 850 S from Kalama Chemical) or also a mixture of diethylene glycol dibenzoate, of dipropylene glycol dibenzoate and of tricthylene glycol dibenzoate (for example available under the name Benzoflex® 2088 from Eastman).

Mention may be made, among the pentaerythritol esters, for example, of pentaerythrityl tetravalerate (for example available under the name Pevalen™ from Perstorp).

Mention may be made, among the cyclohexanedicarboxylates, for example, of diisononyl 1,2-cyclohexanedicarboxylate (for example available under the name Hexamoll Dinch® from BASF) and 1,4-bis(2-ethylhexyl) 1,4-cyclohexanedicarboxylate (for example available under the name DEHCH from Connect Chemicals).

The total content of plasticizer(s) in the composition according to the invention can range from 0% to 30% by weight, preferably from 1% to 30% by weight, indeed even, for example, from 1% to 15% by weight, with respect to the total weight of said composition.

The composition according to the invention can also comprise an antioxidant (also denoted by the term UV stabilizer).

Antioxidants are compounds which can be introduced in order to protect the composition from degradation resulting from a reaction with oxygen which is liable to be formed by the action of heat or of light. These compounds can include primary antioxidants which trap free radicals. The primary antioxidants can be used alone or in combination with other secondary antioxidants or UV stabilizers.

Mention may be made, for example, of Irganox® 1010, Irganox® B561, Irganox® 245, Irganox® 1076 or Irgafos® 168, which are sold by BASF.

An amount of antioxidant ranging from 0.1% to 3%, preferably from 1% to 3%, by weight, on the basis of the total weight of the composition according to the invention, is generally used.

According to one embodiment, the crosslinkable adhesive composition according to the invention comprises:
from 3% to 90% by weight, preferably from 5% to 80% by weight, preferentially from 10% to 70% by weight, in particular from 20% to 60% by weight, advantageously from 36% to 56% by weight, of at least one polymer (A) comprising a hydrolyzable alkoxysilane group,
from 8% to 80% by weight, in particular from 15% to 80% by weight, preferably from 20% to 70% by weight, preferentially from 25% to 70% by weight, especially from 30% to 60% by weight, advantageously from 40% to 60% by weight, of at least one tackifying resin (B),
from 1% to 10% by weight, preferably from 2% to 8% by weight, advantageously from 2% to 6% by weight, of the pyrogenic silica (C), and
from 0.01% to 10% by weight, preferably from 0.01% to 5% by weight, preferentially from 0.05% to 4% by weight, advantageously from 0.1% to 3% by weight, in particular from 0.5% to 2% by weight, of crosslinking catalyst (D),
these percentages by weight being indicated on the basis of the total weight of said composition.

When, according to a preferred alternative form of the invention, the crosslinkable adhesive composition additionally comprises a silsesquioxane resin (E), the amount of the latter can vary from 0.1% to 20% by weight, preferably from 1% to 20% by weight, preferentially from 2% to 15% by weight, advantageously from 3% to 12% by weight, on the basis of the total weight of said composition.

The crosslinkable adhesive composition according to the invention can be prepared by a process which comprises:
a stage of mixing, with the exclusion of air, preferably under an inert atmosphere, the polymer (A), the tackifying resin (B) and, if appropriate, the other optional additives, to form a part (PA); then
a stage of mixing the crosslinking catalyst (D) with, when it is present, the silsesquioxane resin (E), to form a part (PB); then
a stage of incorporation of the pyrogenic silica (C) in the part (PA), at a temperature of between 50° C. and 180° C., preferably between 100° C. and 150° C., until a homogeneous mixture (PC) is obtained; and finally
a stage of mixing of (PC) with (PB).

### Self-Adhesive Article:

Another subject-matter of the present invention is a self-adhesive article comprising a support layer coated with a self-adhesive layer, characterized in that said self-adhesive layer consists of the adhesive composition according to the invention in the crosslinked state.

Within the meaning of the present invention, the term “self-adhesive article” includes any article which can be adhesively bonded to a surface solely by the action of pressure with the hand or an item of equipment, without the use of additional glues or adhesives.

The self-adhesive article is a pressure-sensitive self-adhesive article.

The support layer coated with a self-adhesive layer is also denoted by the term “self-adhesive support”.

These articles have in particular the aim of being applied to a surface to be adhesively bonded in order to bring together, to maintain, to attach, to assemble or simply to immobilize, to expose forms, logos, images or information. These articles can be used in many fields, such as the medical field, clothing, packaging, motor vehicles (for example for attaching logos, lettering, interior soundproofing, interior trim, bonding in the passenger compartment) or construction (for example for sound and thermal insulation, the assembling of windows). They can be fashioned as a function of their final application, for example in the form of tapes, such as tapes for industrial use, tapes for do-it-yourself work or for fixing use on worksites, single-sided or double-sided tapes, or in the form of labels, bandages, dressings, patches or graphic films.

According to one embodiment, the self-adhesive article is a self-adhesive multilayer system, and in particular a self-adhesive label or tape, which can be single-sided or double-sided.

The material which can be used for the support layer can, for example, be any type of rigid or flexible support. Mention may be made, for example, of supports of the type of foams, felts, nonwoven supports, plastics, membranes, papers or a film of a polymer material having one or more layers, in particular a nonstick protective paper or plastic film.

The support layer is made of a material chosen, for example, from polyolefins, such as polyethylene, including high-density polyethylene, low-density polyethylene, linear low-density polyethylene and linear ultra-low-density polyethylene; polypropylene and polybutylenes; polystyrene; natural or synthetic rubber; vinyl copolymers, such as polyvinyl chloride, which may or may not be plasticized, and poly(vinyl acetate)s; olefinic copolymers, such as ethylene/methacrylate copolymers, ethylene/vinyl acetate copolymers, acrylonitrile/butadiene/styrene copolymers and ethylene/propylene copolymers; acrylic polymers and copolymers; polyurethanes; polyethers; polyesters; and the mixtures of these. Preferably, the support layer is based on acrylic polymers, polyethylene (PE), polypropylene (PP), which may be oriented, nonoriented or biaxially oriented, polyimide, polyurethane, polyester, such as polyethylene terephthalate (PET), or paper.

According to one embodiment, the self-adhesive article obtained from the adhesive composition according to the invention comprises a permanent support layer coated with an adhesive layer. Preferably, the adhesive layer is in addition coated with a nonstick protective paper or plastic film, which is preferably silicone-treated.

According to another embodiment, the self-adhesive article obtained from the adhesive composition according to the invention comprises a nonpermanent support layer which consists of a first nonstick protective paper or plastic film, which is preferably silicone-treated, said layer being coated with an adhesive layer, which can itself also be coated with a second nonstick protective paper or plastic film. This embodiment is particularly suitable for the assembling of windows by adhesive bonding, more particularly for the assembling of the rigid panel consisting of the double or triple glazing with the frame of the window. According to this embodiment, said nonpermanent support layer is intended to be removed by the user at the time of the use of the self-adhesive article for the purpose of the assembling of the window, so as to reveal the sole crosslinked adhesive layer, the mechanical properties, in particular the breaking strength, of which are, in accordance with the invention, particularly improved.

As an alternative to the nonstick protective film, the rear face of the permanent support layer, which is not coated with the adhesive layer, can have a nonstick surface, for example a silicone-treated protective layer.

According to another embodiment, the permanent support layer is coated on both its faces with an adhesive composition, which can be identical or different, at least one of the two adhesive compositions being according to the invention, advantageously resulting in the manufacture of “double-sided” tapes.

Preferably, the support layer exhibits a thickness ranging from 10 micrometers to 50 mm, more preferably ranging from 10 micrometers to 20 mm, preferably ranging from 20 micrometers to 10 mm, more preferably ranging from 20 micrometers to 1 mm.

In certain specific cases, it is necessary to carry out a surface treatment on the support layer in order to enhance the attachment of the adhesive layer during the stage of coating thereon.

The self-adhesive article according to the invention can thus adhesively bond two substrates. The substrate onto which the self-adhesive article is intended to be applied (denoted by “substrate to be adhesively bonded”) can be flexible or rigid. In particular, it can exhibit the same flexibility properties as the support layer described above, so as to be wound and packaged in the form of a reel, for example as described above.

Alternatively, the substrate to be adhesively bonded can be rigid. In this case, the substrate cannot be wound and packaged in the form of a reel, for example as described above. The substrate to be adhesively bonded can be chosen, for example, from concrete, paper, substrates of polyolefin type, glass, ceramic and metals, in particular aluminum.

The self-adhesive layer, which consists of the adhesive composition according to the invention in the crosslinked state and which covers the support layer in the self-adhesive article according to the invention, can have a very variable thickness, ranging from 10 μm to 5000 μm, preferably.

A thickness ranging from 10 μm to 100 μm, preferably from 20 μm to 50 μm, is more particularly preferred in the case of self-adhesive labels, whereas a thickness ranging in a much broader interval of from 3 μm to 5000 μm may be encountered for self-adhesive tapes.

According to one embodiment, the self-adhesive article additionally comprises a protective nonstick layer (release liner).

According to one embodiment, said nonstick layer is applied to the adhesive layer, after crosslinking of the adhesive composition.

The support layer can be covered, on that of its two faces which is not coated with the adhesive layer, with a protective nonstick layer, for example with a silicone film. In this way, the self-adhesive article can be wound up on itself and then unwound without any problem by virtue of the absence of adhesion of the adhesive layer to the silicone-treated face.

### Method for the Manufacture of the Self-Adhesive Article:

Another subject-matter of the present invention is a process for the manufacture of the self-adhesive article as defined above, said process being characterized in that it comprises:
(a) the application of said composition by coating onto a carrying surface;
(b) the crosslinking of said composition, by heating at a temperature ranging from 15° C. to 200° C.; and then
(c) the lamination or the transfer of the layer of crosslinked adhesive composition onto a support layer or onto a nonstick protective film.

“Carrying surface” should be understood as meaning, within the meaning of the present invention, either a belt conveyor covered with a nonstick layer, or a nonstick protective film (release liner), or a support layer.

In the case where the carrying surface is a nonstick protective film, the process for the manufacture of the self-adhesive article according to the invention can comprise the stage (c) of transfer of the crosslinked adhesive layer onto a support layer.

In the case where the carrying surface is a support layer or a nonstick protective film, the process for the manufacture of the self-adhesive article according to the invention can also comprise the stage (c) of lamination of the adhesive layer onto a nonstick protective film.

According to a preferred alternative form of the invention, stage (c) of the process described above consists of a transfer of the crosslinked adhesive layer onto a flexible support layer (which can be a plastic film), if appropriate after cooling the crosslinked adhesive layer to a temperature below the degradation temperature or softening point of the material of which the support layer is composed.

According to one embodiment, the process for the manufacture of the self-adhesive article according to the invention additionally comprises a stage (d) of coating a second layer of adhesive composition according to the invention onto the support layer, followed by a stage (e) of crosslinking the adhesive composition coated in stage (d) by heating to a temperature ranging from 15° C. to 200° C., preferably from 15° C. to 45° C., preferably at ambient temperature, especially between 18° C. and 25° C., in particular at 23° C. According to this embodiment, a double-sided self-adhesive article is obtained.

The coating stage (a) can be carried out by means of known coating devices, such as, for example, a lip nozzle or a nozzle of curtain type, or also with a roller. It employs a weight per unit area of adhesive composition which can range from 3 g/m² to 5000 g/m², in particular from 10 g/m² to 5000 g/m².

The weight per unit area of adhesive composition necessary for the manufacture of self-adhesive labels can range from 10 g/m² to 100 g/m², preferably from 20 g/m² to 50 g/m². That necessary for the manufacture of self-adhesive tapes can vary within a much wider range extending from 3 g/m² to 5000 g/m², preferably from 15 g/m² to 250 g/m², per face.

The crosslinking stage (b) is, according to a preferred alternative form of the invention, carried out at a temperature ranging from 15° C. to 45° C., preferably at ambient temperature, especially between 18° C. and 25° C., in particular at 23° C.

According to one embodiment, the coated adhesive composition is additionally subjected, during the crosslinking stage (b), to a treatment in a humid atmosphere characterized by its moisture level and, in particular, in a gaseous environment where water molecules are present at between 10 and 200 g per m³ of gas.

Preferably, the humid atmosphere is an atmosphere in which from 2% to 100% of the molecules are water molecules, preferably from 3% to 50%, more preferably from 3% to 10%, of the molecules are water molecules.

The moisture content is expressed as percentage of water per unit of volume, which corresponds to the number of water molecules divided by the total number of molecules in a unit of volume. By virtue of the linear nature of this scale, the moisture content is readily measured and monitored by using, for example, monitors of PID (Proportional-Integral-Derivative) type. The percentage by weight can be calculated by multiplying the percentage of the number of water molecules with respect to the total number of molecules by a factor of 0.622. General information regarding the moisture content in various environments is described by W. Wagner et al. in “International Steam Tables Properties of Water and Steam based on the Industrial Formulation IAPWS-IF97”.

The crosslinking stage (b) is, according to yet another preferred alternative form of the invention, carried out without control of the humidity, very particularly at the humidity of the ambient atmosphere, in particular at an absolute humidity of 20 to 60 g of water per m³ of air, preferably of 40 to 60 g/m³.

This crosslinking stage (b) has in particular the effect of the creation-between the polymer chains having hydrolyzable alkoxysilane end group of the adhesive composition and under the action of atmospheric moisture—of bonds of siloxane type which result in the formation of a three-dimensional polymeric network. The adhesive composition thus crosslinked is in particular a pressure-sensitive adhesive which gives the support layer which is coated with it the desirable adhesiveness and the desirable tack.

Preferably, the coating is carried out uniformly over the support layer or over the nonstick protective layer but the coating can also be adapted to the desired shape of the final self-adhesive article.

According to one embodiment, the coating with the adhesive composition is carried out over at least a portion of the two faces of the support layer. If the two faces of the support layer are coated, the adhesive composition can be identical or different on the two faces and the weight per unit area can be identical or different on the two faces.

According to one embodiment of the invention, the self-adhesive article comprises an adhesive layer on at least a portion of a face or on at least a portion of the two faces of the support layer, said adhesive layer(s) being optionally coated with a nonstick protective layer. According to one embodiment, the self-adhesive article comprises two nonstick protective layers on each of the two adhesive layers. In this case, the two protective layers can be made of identical or different materials and/or they can have an identical or different thickness.

Finally, a subject-matter of the present invention is an adhesive bonding method employing the self-adhesive article as defined above, characterized in that it comprises the following stages:
a) the removal of the nonstick protective layer, when such a layer is present;
b) the application of the self-adhesive article to a surface of a product; and
c) the application of a pressure to said article.

In stage b), the self-adhesive article is applied so that the self-adhesive portion of the article (formed by the self-adhesive layer) is facing the surface of the product.

According to an embodiment in which the self-adhesive article is a double-sided article, the adhesive bonding method additionally comprises a stage in which either a second surface of a product is applied to the article adhesively bonded to the first surface of a product, or the article adhesively bonded to the first surface of a product is applied to a second surface of a product.

The following examples are given purely by way of illustration of the invention and should not be interpreted to limit the scope thereof.

### Example A (Comparative According to WO 2020/128200)

Heat-crosslinkable adhesive composition based on Geniosil® STP-E30

### A1. Preparation of the Composition:

The composition appearing in table 1 is prepared by first of all introducing the tackifying resin Picco® AR100 into a glass reactor under vacuum and heated to approximately 160° C. Then, once the resin has fully melted, the Geniosil® STP-E30 is added.

The mixture is stirred under vacuum for 15 minutes and then cooled to 70° C. The catalyst (K-KAT® 5218) and the silsesquioxane Dow Corning® 3074 are then introduced. The mixture is kept under vacuum and with stirring for a further 10 minutes.

### A2. Measurement of the Crosslinking Time at Ambient Temperature:

The composition of example A is applied so as to fill a mold corresponding to a test specimen of H2 type, as defined by the standard NF T46-002, the thickness of which is 4 mm and the central part of which exhibits a rectangular section of 4×2 mm over a length of 25 mm.

Said mold is left at ambient temperature (approximately 23° C.) and the behavior of the composition is observed. The time necessary for the complete crosslinking is 24 h.

### A3. Measurement of the Breaking Stress and of the Elongation at Break by a Tensile Test:

The principle of the measurement consists in drawing, in a tensile testing device, the movable jaw of which moves at a constant rate equal to 100 mm/minute, a test specimen of H2 type as defined above consisting of the crosslinked adhesive composition and in recording, at the moment when the test specimen breaks, the stress applied (in MPa) and also the elongation of the test specimen (in %).

The results of the measurements obtained are shown in table 1.

A4. Preparation of a PET Support Layer Coated with the Crosslinked Composition, in a Proportion of a Weight Per Unit Area Equal to 60 g/m²:

A rectangular sheet of PolyEthylene Terephthalate (PET) with a thickness of 50 μm and with dimensions of 20 cm by 40 cm is used as support layer.

The composition obtained in point A1 is preheated to a temperature close to 100° C. and is introduced into a cartridge, from where a bead is extruded which is deposited close to the edge of the sheet parallel to its width.

The composition included in this bead is subsequently spread over the whole surface of the sheet, so as to obtain a uniform layer of substantially constant thickness. A film spreader (also known as a film applicator) is used to do this, and is moved from the edge of the sheet to the opposite edge. A layer of composition corresponding to a weight per unit area of 60 g/m² is thus deposited, which represents approximately a thickness of the order of 60 μm.

The PET sheet thus coated is then placed in an oven at 120° C. and under a humid atmosphere (4% relative humidity) for 5 minutes for crosslinking of the composition and then laminated on a nonstick protective layer consisting of a sheet of silicone film which is rectangular and of the same dimensions.

The triple layer obtained is subjected to the tests described below.

### A4.1 Peeling at Ambient Temperature:

The adhesiveness is evaluated by the 180° peel test on a stainless steel plate, as described in the FINAT No. 1 method, published in the FINAT Technical Handbook, 6th edition, 2001. FINAT is the international federation of self-adhesive label manufacturers and converters. The principle of this test is as follows:

A test specimen in the form of a rectangular strip (2.54 cm×15 cm) is cut out from the triple layer obtained above.

This test specimen is stored at ambient temperature under ambient atmosphere (approximately 23° C. et 50% humidity) for 7 hours. Then, after removal of the corresponding portion of protective nonstick layer, it is attached over ⅔ of its length to a substrate consisting of a stainless steel plate.

The assembly obtained is left at ambient temperature (approximately 23° C.) for 20 minutes. It is then placed in a tensile testing device capable, starting from the end of the rectangular strip which has remained free, of carrying out the peeling or detachment of the strip at an angle of 180° and with a separation speed of 300 mm per minute. The instrument measures the force required to detach the strip under these conditions.

The corresponding result is expressed in N/2.54 cm and is shown in table 1.

A4.2 Peeling after 7 Days of Storage at 50° C.:

The preceding test is repeated, except that, after cutting out the test specimen in the form of a rectangular strip, the latter is stored for 7 days at a temperature of 50° C. and in an atmosphere at 50% humidity, before being attached to the stainless steel plate.

The corresponding result is expressed in N/2.54 cm and is shown in table 1.

### A4.3 Instantaneous Adhesion (Also Known as Loop Test):

The immediate tackiness or tack is evaluated by the instantaneous adhesion, “loop”, test, described in the FINAT No. 9 method, the principle of which is as follows:

A test specimen in the form of a rectangular strip (25 mm×175 mm) is cut out from the PET support layer coated with the crosslinked composition obtained above.

After removal of all of the protective nonstick layer, the two ends of this strip are joined so as to form a loop, the adhesive layer of which is directed toward the outside. The two joined ends are placed in the movable jaw of a tensile testing device capable of imposing a displacement rate of 300 mm/minute along a vertical axis, with a to-and-fro option. The lower part of the loop placed in the vertical position is first brought into contact with a horizontal sheet of glass of 25 mm by 30 mm over a square region with a side length of approximately 25 mm. Once this contact has occurred, the direction of displacement of the jaw is reversed. The tack is the maximum value of the force necessary for the loop to become completely detached from the sheet.

The result is expressed in N/(2.54 cm)² and is shown in table 1.

### A4.4 Shear Strength Time at 125° C.:

The maintenance at high temperature of the adhesiveness of the PET support layer obtained above is evaluated by a test which determines the time of resistance of the adhesive seal to static shearing at 125° C. Reference is made, for this test, to the FINAT No. 8 method. The principle is as follows:

A test specimen in the form of a rectangular strip (25 mm×75 mm) is cut out from the triple layer obtained above and is stored at ambient temperature (23° C., 50% humidity) for 24 hours.

After removal of all of the protective nonstick layer, a square portion with a side length of 25 mm located at the end of the adhesive strip is attached to a glass plate.

The test plate thus obtained is introduced, by means of an appropriate support, in a substantially vertical position into an oven at 125° C., the nonadhesively bonded part of the strip with a length of 50 mm being located below the plate. After thermal equilibration, the portion of the strip which has remained free is connected to a 1 kg weight, the entire device always remaining held in the oven at 125° C. throughout the duration of the test.

Under the effect of this weight, the adhesive seal which provides the attaching of the strip to the plate is subjected to a shear stress. For more effective monitoring of this stress, the test plate is in fact placed so as to form an angle of 2° with respect to the vertical.

The time at the end of which the strip detaches from the plate following the failure of the adhesive seal under the effect of this stress is recorded.

The result, expressed in hours, is shown in table 1.

A4. 5 Shear Strength Time at 125° C. after 7 Days of Storage of the Test Specimen at 50° C.:

The preceding test is repeated, except that, after cutting out the test specimen in the form of a rectangular strip, the latter is stored for 7 days at a temperature of 50° C. and in an atmosphere at 50% humidity, before being attached to the glass plate.

The result, expressed in hours, is shown in table 1.

### Examples B and C: Comparative Adhesive Compositions Based on Geniosil® STP-E30

The preparation of the composition of example A as shown in point A1 is repeated, except that:
for example B: silsesquioxane is not introduced,
for example C: silsesquioxane is not introduced and, after addition of the catalyst and then stirring for 10 minutes, Aerosil® R202 is introduced and stirring is again carried out for approximately 10 minutes.

The measurement of the crosslinking time at ambient temperature, and also the tensile test and the test of shear strength at 125° C., as shown in points A2, A3 and A4, are repeated. The results shown in table 1 are obtained.

### Examples 1 and 2 According to the Invention: Adhesive Compositions Crosslinkable at Ambient Temperature Based on Geniosil® STP-E30

The preparation of the composition of example A as shown in point A1 is repeated, except that, after addition of the catalyst and of the silsesquioxane and then stirring for 10 minutes, Aerosil® R202 is introduced and stirring is again carried out for approximately 10 minutes.

The measurement of the crosslinking time at ambient temperature and the tensile test, as shown in points A2 and A3, are repeated. The results shown in table 1 are obtained. It is observed, for example 2, that the crosslinking time at ambient temperature is, compared with example B, considerably decreased (by more than a factor of 2). In addition, it is observed, for example 2, that the breaking stress is markedly increased, compared with example B. In point of fact, the separate addition of silsesquioxane resin (E) or of pyrogenic silica (C) results in a decrease in the breaking stress (examples A and C). The increase in the breaking stress observed for the addition of a combination of silsesquioxane resin (E) and of pyrogenic silica (C) is thus completely unexpected and demonstrates a synergy between these ingredients.

The preparation of the self-adhesive PET support layer, as shown in point A4, is also repeated, except that the coated PET sheet is left at ambient temperature (approximately 23° C.) for 7 h for crosslinking, before being laminated on the protective nonstick layer. The triple layer obtained is subsequently subjected to the tests described in points A4.1 to A4.5, which lead to the results shown in table 1.

For examples 1 and 2, peel results (at ambient temperature or after storage for 7 days at 50° C.) are observed which are substantially identical to those of example A.

The instantaneous adhesion (or tack) values obtained for these two examples are, although lower than those of example A, entirely suitable for a self-adhesive support.

Finally, the results show that the addition of silsesquioxane resin (E) (example A) results in an improvement in the shear strength at 125° C. (comparison with example B), whereas the addition of pyrogenic silica (C) (example C) has virtually no effect on the shear strength at 125° C. On the other hand, the values of shear strength at 125° C. measured for the self-adhesive PET layers of examples 1 and 2 demonstrate a temperature cohesion far superior to that of examples A, B and C. Thus, the addition of a combination of silsesquioxane resin (E) and of pyrogenic silica (C) makes it possible to improve, surprisingly, the shear strength at 125° C., these ingredients acting in synergy. In addition, the self-adhesive PET layers of examples 1 and 2 retain these properties of shear strength at 125° C. even after storage for 7 days at 50° C.

TABLE 1

| | | Content in % weight/weight | | | | |
|---|---|---|---|---|---|---|
| Ingredient | | Example A | Example B | Example C | Example 1 | Example 2 |
| (A) | Geniosil ® STP-E30 | 42.4 | 44.7 | 42.4 | 40.84 | 40.19 |
| (B) | Picco ® AR100 | 51.6 | 54.3 | 51.6 | 49.71 | 48.94 |
| (C) | Aerosil ® R202 | — | — | 5 | 3.5 | 5.0 |
| (D) | K-KAT ® 5218 | 1 | 1 | 1 | 0.98 | 0.98 |
| (E) | Dow Corning ® 3074 | 5 | — | — | 4.97 | 4.89 |

| | | | | | |
|---|---|---|---|---|---|
| Crosslinking time at ambient | 24 | 18 | 5.67 | ND | 7 |
| temperature (hours) | | | | | |
| Peeling at ambient temperature | 19 | ND | ND | 21 | 20 |
| (N/2.54 cm) | | | | | |
| Peeling after 7 days at 50° C. | 22 | ND | ND | 21 | 20 |
| (N/2.54 cm) | | | | | |
| Instantaneous adhesion | 36 | ND | ND | 23 | 18 |
| (N/(2.54 cm)²) | | | | | |
| Shear strength time at 125° C. | 24 | 16 | 15.5 | 70 | 40 |
| (hours) | | | | | |
| Shear strength time at 125° C. | 25 | ND | ND | 70 | 42 |
| after 7 days at 50° C. (hours) | | | | | |
| Breaking stress (in MPa) | 0.16 | 0.28 | 0.11 | ND | 0.39 |
| Elongation at break (in %) | 326 | ND | ND | ND | 300 |

ND = Not Determined

1. A crosslinkable adhesive composition, characterized in that it comprises:
at least one polymer (A) comprising a hydrolyzable alkoxysilane group;
at least one tackifying resin (B);
at least one pyrogenic silica (C);
at least one crosslinking catalyst (D); and
a silsesquioxane resin (E).

2. The adhesive composition as claimed in claim 1, characterized in that the polymer (A) comprises at least one, hydrolyzable group of formula (I):
Si(R⁴)ₚ(OR⁵)₃₋ₚ (I)
in which:
R⁴ represents a linear or branched alkyl radical comprising from 1 to 4 carbon atoms, with the possibility that, when there are several R⁴ radicals, these radicals are identical or different;
R⁵ represents a linear or branched alkyl radical comprising from 1 to 4 carbon atoms, with the possibility that, when there are several R⁵ radicals, these radicals are identical or different, with the possibility that two OR⁵ groups can participate in one and the same ring; and
p is an integer equal to 0, 1 or 2.

3. The adhesive composition as claimed in claim 2, characterized in that the polymer (A) corresponds to one of the formulae (II), (III) or (IV): 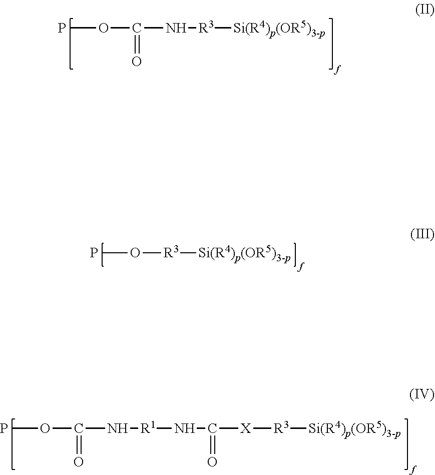
in which:
P represents a saturated or unsaturated, linear or branched, polymeric radical optionally comprising one or more heteroatoms, such as oxygen, nitrogen, sulfur or silicon, and,
R¹ represents a divalent hydrocarbon radical comprising from 5 to 15 carbon atoms which can be aromatic or aliphatic, linear, branched or cyclic,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms, and which can also comprise one or more heteroatoms, and
f is an integer ranging from 1 to 6.

4. The adhesive composition as claimed in claim 3, characterized in that the polymer (A) corresponds to one of the formulae (II′), (III′) or (IV′): 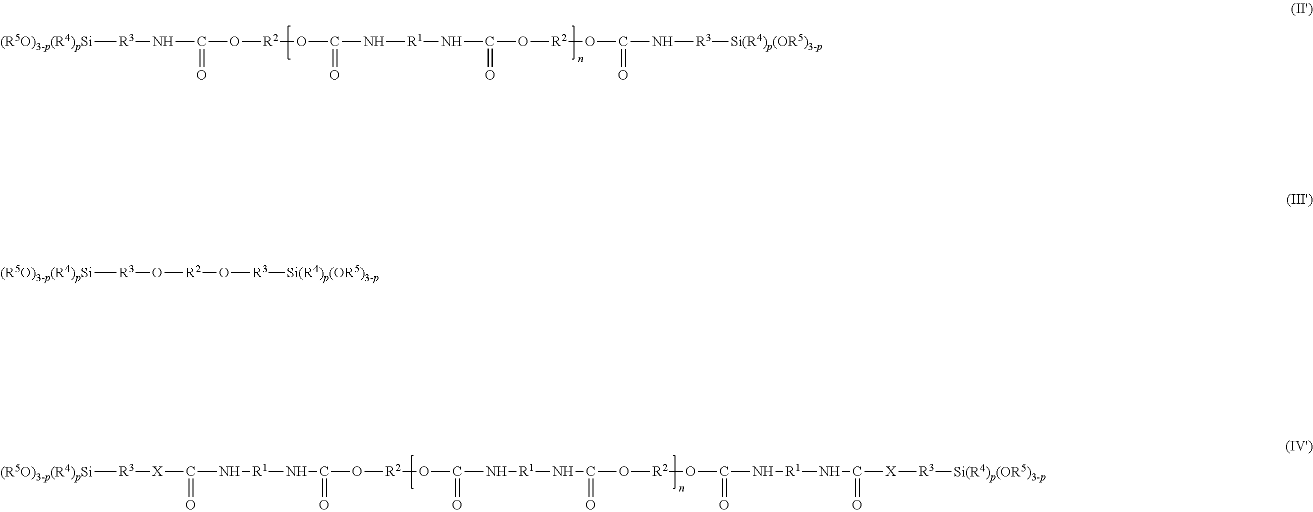
in which:
R² represents a saturated or unsaturated, linear or branched, divalent hydrocarbon radical optionally comprising one or more heteroatoms, such as oxygen, nitrogen, sulfur or silicon, and
n is an integer greater than or equal to 0.

5. The adhesive composition as claimed in claim 1, characterized in that the tackifying resin (B) is chosen from:
(i) resins obtained by polymerization of terpene hydrocarbons and of phenols, in the presence of Friedel-Crafts catalysts;
(ii) resins obtained by a process comprising the polymerization of α-methylstyrene, it also being possible for said process to comprise a reaction with phenols;
(iii) rosins of natural origin or modified rosins;
(iv) resins obtained by hydrogenation, polymerization or copolymerization of mixtures of unsaturated aliphatic hydrocarbons having approximately 5, 9 or 10 carbon atoms resulting from petroleum fractions;
(v) terpene resins;
(vi) copolymers based on natural terpenes; or else
(vii) acrylic resins having a viscosity at 100° C. of less than 100 Pa·s.

6. The adhesive composition as claimed in claim 1, characterized in that the pyrogenic silica (C) is hydrophobic.

7. The adhesive composition as claimed in claim 6, characterized in that the hydrophobic pyrogenic silica (C) is obtained by treatment of a pyrogenic silica with a polydimethylsiloxane.

8. The adhesive composition as claimed in claim 1, characterized in that the pyrogenic silica (C) has a BET specific surface of at least 10 m²/g.

9. The adhesive composition as claimed in claim 1, characterized in that the silsesquioxane resin (E) corresponds to the following general formula (V): 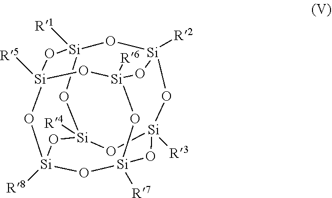
in which each of R′¹ to R′⁸ represents, independently of one another, a group chosen from:
a hydrogen atom,
a radical chosen from the group consisting of a linear or branched C₁-C₄ alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
an —OSiR′⁹R′¹⁰ group in which R′⁹ and R′¹⁰ each represents, independently of each other, a hydrogen atom or a radical chosen from the group consisting of linear or branched C₁-C₄ alkyls, linear or branched C₁-C₄ alkoxys, C₂-C₄ alkenyls, a phenyl, a C₃-C₆ allyl radical, a cyclic C₃-C₈ aliphatic radical and a C₁-C₄ acyl radical;
provided:
that at least one radical among the R′¹ to R′⁸ radicals is a C₁-C₄ alkoxy radical; and
that at least one radical among the R′¹ to R′⁸ radicals is a phenyl radical.

10. The adhesive composition as claimed in claim 1, characterized in that it comprises:
from 3% to 90% by weight of at least one polymer (A);
from 8% to 80% by weight of at least one tackifying resin (B);
from 1% to 10% by weight of the pyrogenic silica (C);
from 0.01% to 10% by weight of crosslinking catalyst (D); and
from 0.1% to 20% by weight of silsesquioxane resin (E);
these percentages by weight being indicated on the basis of the total weight of said composition.

11. A self-adhesive article comprising a support layer coated with a self-adhesive layer, characterized in that said self-adhesive layer consists of the adhesive composition as defined in claim 1 in the crosslinked state.

12. A process for the manufacture of the self-adhesive article as defined in claim 11, characterized in that it comprises:
(a) the application of said adhesive composition by coating onto a carrying surface;
(b) the crosslinking of said adhesive composition to form a layer, by heating at a temperature ranging from 15° C. to 200° C.; and then
(c) the lamination or the transfer of the layer of crosslinked adhesive composition onto a support layer or onto a nonstick protective film.

13. The process for the manufacture of the self-adhesive article as claimed in claim 12, characterized in that the crosslinking stage b) is carried out at a temperature ranging from 15° C. to 45° C.

14. An adhesive bonding method employing the self-adhesive article as defined in claim 11, characterized in that it comprises the following stages:
a) the removal of the nonstick protective layer, when such a layer is present;
b) the application of the self-adhesive article to a surface of a product; and
c) the application of a pressure to said article.
